(19) United States
(12) Patent Application Publication
(10) Pub. No.: US 2013/0036872 A1
(43) Pub. Date: Feb. 14, 2013

(54) Modular Fixed Cutter Earth-Boring Bits, Modular Fixed Cutter Earth-Boring Bit Bodies, and Related Methods

(71) Applicant: TDY Industries, LLC, Pittsburgh, PA (US)

(72) Inventors: Prakash K. Mirchandani, Houston, TX (US); Michale E. Waller, Huntsville, AL (US); Jeffrey L. Weigold, Huntsville, AL (US); Alfred J. Mosco, Spring, TX (US)

(73) Assignee: TDY INDUSTRIES, LLC, Pittsburgh, PA (US)

(21) Appl. No.: 13/652,503

(22) Filed: Oct. 16, 2012

Related U.S. Application Data
(63) Continuation of application No. 11/737,993, filed on Apr. 20, 2007, now Pat. No. 8,312,941.
(60) Provisional application No. 60/795,290, filed on Apr. 27, 2006.

(51) Int. Cl. B23P 15/32

(52) U.S. Cl. 76/108.4

(57) ABSTRACT

A modular fixed cutter earth-boring bit body includes a blade support piece and at least one blade piece fastened to the blade support piece. A modular fixed cutter earth-boring bit and methods of making modular fixed cutter earth-boring bit bodies and bits also are disclosed.

### CROSS-REFERENCE TO RELATED APPLICATIONS

The present application is a continuation application claiming priority under 35 U.S.C. §120 to co-pending U.S. patent application Ser. No. 11/737,993, filed on Apr. 20, 2007, which in turn claims priority under 35 U.S.C. §119(e) to U.S. provisional patent application Ser. No. 60/795,290, filed Apr. 27, 2006, now lapsed. Each of the foregoing earlier-filed applications is hereby incorporated by reference herein in its entirety.

### TECHNICAL FIELD OF THE INVENTION

The present invention relates, in part, to improvements to earth-boring bits and methods of producing earth-boring bits. The present invention further relates to modular earth-boring bit bodies and methods of forming modular earth-boring bit bodies.

### BACKGROUND OF THE TECHNOLOGY

Earth-boring bits may have fixed or rotatable cutting elements. Earth-boring bits with fixed cutting elements typically include a bit body machined from steel or fabricated by infiltrating a bed of hard particles, such as cast carbide (WC+W₂C), macrocystalline or standard tungsten carbide (WC), and/or sintered cemented carbide with a copper-base alloy binder. Conventional fixed cutting element earth-boring bits comprise a one-piece bit body with several cutting inserts in insert pockets located on the bit body in a manner designed to optimize cutting. It is important to maintain the inserts in precise locations to optimize drilling efficiency, avoid vibrations, and minimize stresses in the bit body in order to maximize the life of the earth-boring bit. The cutting inserts are often based on highly wear resistant materials such as diamond. For example, cutting inserts may consist of a layer of synthetic diamond placed on a cemented carbide substrate, and such inserts are often referred to as polycrystalline diamond compacts (PDC). The bit body may be secured to a steel shank that typically includes a threaded pin connection by which the bit is secured to a drive shaft of a downhole motor or a drill collar at the distal end of a drill string. In addition, drilling fluid or mud may be pumped down the hollow drill string and out nozzles formed in the bit body. The drilling fluid or mud cools and lubricates the bit as it rotates and also carries material cut by the bit to the surface.

Conventional earth-boring bit bodies have typically been made in one of the following ways, for example, machined from a steel blank or fabricated by infiltrating a bed of hard carbide particles placed within a mold with a copper based binder alloy. Steel-bodied bits are typically machined from round stock to a desired shape, with topographical and internal features. After machining the bit body, the surface may be hard-faced to apply wear-resistant materials to the face of the bit body and other critical areas of the surface of the bit body.

In the conventional method for manufacturing a bit body from hard particles and a binder, a mold is milled or machined to define the exterior surface features of the bit body. Additional hand milling or clay work may also be required to create or refine topographical features of the bit body.

Once the mold is complete, a preformed bit blank of steel may be disposed within the mold cavity to internally reinforce the bit body matrix upon fabrication. Other transition or refractory metal based inserts, such as those defining internal fluid courses, pockets for cutting elements, ridges, lands, nozzle displacements, junk slots, or other internal or topographical features of the bit body, may also be inserted into the cavity of the mold. Any inserts used must be placed at precise locations to ensure proper positioning of cutting elements, nozzles, junk slots, etc., in the final bit.

The desired hard particles may then be placed within the mold and packed to the desired density. The hard particles are then infiltrated with a molten binder, which freezes to form a solid bit body including a discontinuous phase of hard particles within a continuous phase of binder.

The bit body may then be assembled with other earth-boring bit components. For example, a threaded shank may be welded or otherwise secured to the bit body, and cutting elements or inserts (typically diamond or a synthetic polycrystalline diamond compact (“PDC”)) are secured within the cutting insert pockets, such as by brazing, adhesive bonding, or mechanical affixation. Alternatively, the cutting inserts may be bonded to the face of the bit body during furnacing and infiltration if thermally stable PDC's (“TSP”) are employed.

The bit body and other elements of earth-boring bits are subjected to many forms of wear as they operate in the harsh down hole environment. Among the most common form of wear is abrasive wear caused by contact with abrasive rock formations. In addition, the drilling mud, laden with rock cuttings, causes the bit to erode or wear.

The service life of an earth-boring bit is a function not only of the wear properties of the PDCs or cemented carbide inserts, but also of the wear properties of the bit body (in the case of fixed cutter bits) or conical holders (in the case of roller cone bits). One way to increase earth-boring bit service life is to employ bit bodies made of materials with improved combinations of strength, toughness, and abrasion/erosion resistance.

Recently, it has been discovered that fixed-cutter bit bodies may be fabricated from cemented carbides employing standard powder metallurgy practices (powder consolidation, followed by shaping or machining the green or presintered powder compact, and high temperature sintering). Such solid, one-piece, cemented carbide based bit bodies are described in U.S. Patent Publication No. 2005/0247491.

In general, cemented carbide based bit bodies provide substantial advantages over the bit bodies of the prior art (machined from steel or infiltrated carbides) since cemented carbides offer vastly superior combinations of strength, toughness, as well as abrasion and erosion resistance compared to steels or infiltrated carbides with copper based binders. FIG. 1 shows a typical solid, one-piece, cemented carbide bit body 10 that can be employed to make a PDC-based earth boring bit. As can be observed, the bit body 10 essentially consists of a central portion 11 having holes 12 through which mud may be pumped, as well as arms or blades 13 having pockets 14 into which the PDC cutters are attached. The bit body 10 of FIG. 1 was prepared by powder metal technologies. Typically, to prepare such a bit body, a mold is filled with powdered metals comprising both the binder metal and the carbide. The mold is then compacted to densify the powdered metal and form a green compact. Due to the strength and hardness of sintered cemented carbides, the bit body is usually machined in the green compact form. The green compact may be machined to include any features desired in the final bit body.

The overall durability and performance of fixed-cutter bits depends not only on the durability and performance of the cutting elements, but also on the durability and performance of the bit bodies. It can thus be expected that earth-boring bits based on cemented carbide bit bodies would exhibit significantly enhanced durability and performance compared with bits made using steel or infiltrated bit bodies. However, earth boring bits including solid cemented carbide bit bodies do suffer from limitations, such as the following:

1. It is often difficult to control the positions of the individual PDC cutters accurately and precisely. After machining the insert pockets, the green compact is sintered to further densify the bit body. Cemented carbide bodies will suffer from some slumping and distortion during high temperature sintering processes and this results in distortion of the location of the insert pockets. Insert pockets that are not located precisely in the designed positions of the bit body may not perform satisfactorily due to premature breakage of cutters and/or blades, drilling out-of-round holes, excessive vibration, inefficient drilling, as well as other problems.

2. Since the shapes of solid, one-piece, cemented carbide bit bodies are very complex (see for example, FIG. 1), cemented carbide bit bodies are machined and shaped from green powder compacts utilizing sophisticated machine tools. For example, five-axis computer controlled milling machines. However, even when the most sophisticated machine tools are employed, the range of shapes and designs that can be fabricated are limited due to physical limitations of the machining process. For example, the number of cutting blades and the relative positions of the PDC cutters may be limited because the different features of the bit body could interfere with the path of the cutting tool during the shaping process.

3. The cost of one-piece cemented carbide bit bodies can be relatively high since a great deal of very expensive cemented carbide material is wasted during the shaping or machining process.

4. It is very expensive to produce a one-piece cemented carbide bit body with different properties at different locations. The properties of solid, one-piece, cemented carbide bit bodies are therefore, typically, homogenous, i.e., have similar properties at every location within the bit body. From a design and durability standpoint, it may be advantageous in many instances to have different properties at different locations.

5. The entire bit body of a one-piece bit body must be discarded if a portion of the bit body fractures during service (for example, the breakage of an arm or a cutting blade).

Accordingly, there is a need for improved bit bodies for earth-boring bits having increased wear resistance, strength and toughness that do not suffer from the limitations noted above.

### BRIEF DESCRIPTION OF THE FIGURES

The features and advantages of the present invention may be better understood by reference to the accompanying figures in which:

FIG. 1 is a photograph of a conventional solid, one-piece, cemented carbide bit body for earth boring bits;

FIG. 2 is photograph of an embodiment of an assembled modular fixed cutter earth-boring bit body comprising six cemented carbide blade pieces fastened to a cemented carbide blade support piece, wherein each blade piece has nine cutting insert pockets;

FIG. 3 is a photograph of a top view of the assembled modular fixed cutter earth-boring bit body of FIG. 2;

FIG. 4 is a photograph of the blade support piece of the embodiment of the assembled modular fixed cutter earth-boring bit body of FIG. 2 showing the blade slots and the mud holes of the blade support piece;

FIG. 5 is a photograph of an individual blade piece of the embodiment of the assembled modular fixed cutter earth-boring bit body of FIG. 2 showing the cutter insert cutter pockets; and

FIG. 6 is a photograph of another embodiment of a blade piece comprising multiple blade pieces that may be fastened in a single blade slot in the blade support piece of FIG. 4.

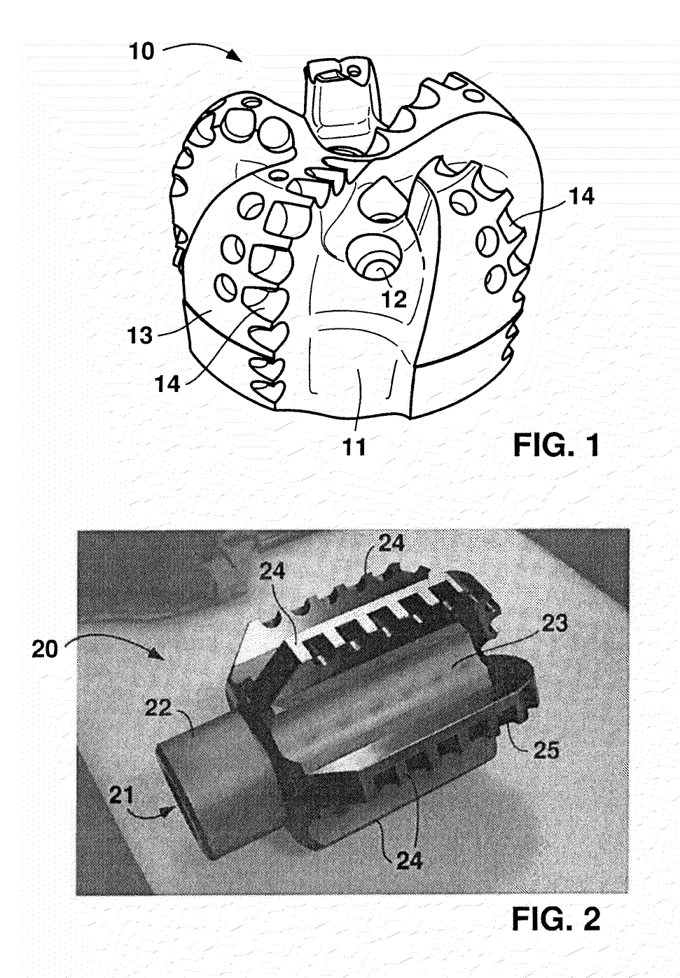

### BRIEF SUMMARY

Certain non-limiting embodiments of the present invention are directed to a modular fixed cutter earth-boring bit body comprising a blade support piece and at least one blade piece fastened to the blade support piece. The modular fixed cutter earth-boring bit body may further comprise at least one insert pocket in the at least one blade piece. The blade support piece, the at least one blade piece, and any other piece or portion of the modular bit body may independently comprise at least one material selected from cemented hard particles, cemented carbides, ceramics, metallic alloys, and plastics.

Further non-limiting embodiments are directed to a method of producing a modular fixed cutter earth-boring bit body comprising fastening at least one blade piece to a blade support piece of a modular fixed cutter earth boring bit body. The method of producing a modular fixed cutter earth-boring bit body may include any mechanical fastening technique including inserting the blade piece in a slot in the blade support piece, welding, brazing, or soldering the blade piece to the blade support piece, force fitting the blade piece to the blade support piece, shrink fitting the blade piece to the blade support piece, adhesive bonding the blade piece to the blade support piece, attaching the blade piece to the blade support piece with a threaded mechanical fastener, or mechanically affixing the blade piece to the blade support piece.

### DESCRIPTION OF CERTAIN NON-LIMITING EMBODIMENTS OF THE INVENTION

One aspect of the present invention relates to a modular fixed cutter earth-boring bit body. Conventional earth boring bits include a one-piece bit body with cutting inserts brazed into insert pockets. The conventional bit bodies for earth boring bits are produced in a one piece design to maximize the strength of the bit body. Sufficient strength is required in a bit body to withstand the extreme stresses involved in drilling oil and natural gas wells. Embodiments of the modular fixed cutter earth boring bit bodies of the present invention may comprise a blade support piece and at least one blade piece fastened to the blade support piece. The one or more blade pieces may further include pockets for holding cutting inserts, such as PDC cutting inserts or cemented carbide cutting inserts. The modular earth-boring bit bodies may comprise any number of blade pieces that may physically be designed into the fixed cutter earth boring bit. The maximum number of blade pieces in a particular bit or bit body will depend on the size of the earth boring bit body, the size and width of an individual blade piece, and the application of the earth-boring bit, as well as other factors known to one skilled in the art. Embodiments of the modular earth-boring bit bodies may comprise from 1 to 12 blade pieces, for example, or for certain applications 4 to 8 blade pieces may be desired.

Embodiments of the modular earth-boring bit bodies are based on a modular or multiple piece design, rather than a solid, one-piece, construction. The use of a modular design overcomes several of the limitations of solid one-piece bit bodies.

The bit bodies of the present invention include two or more individual components that are assembled and fastened together to form a bit body suitable for earth-boring bits. For example, the individual components may include a blade support piece, blade pieces, nozzles, gauge rings, attachment portions, shanks, as well as other components of earth-boring bit bodies.

Embodiments of the blade support piece may include, for example, holes and/or a gauge ring. The holes may be used to permit the flow of water, mud, lubricants, or other liquids. The liquids or slurries cool the earth-boring bit and assist in the removal of dirt, rock, and debris from the drill holes.

Embodiments of the blade pieces may comprise, for example, cutter pockets for the PDC cutters, and/or individual pieces of blade pieces comprising insert pockets.

An embodiment of the modular earth-boring bit body 20 of a fixed cutter earth-boring bit is shown in FIG. 2. The modular earth boring bit body 20 comprises attachment means 21 on a shank 22 of the blade support piece 23. Blades pieces 24 are fastened to the blade support piece 23. It should be noted that although the embodiment of the modular earth boring bit body of FIG. 2 includes the attachment portion 21 and shank 22 as formed in the blade support piece, the attachment portion 21 and shank 22 may also be made as individual pieces to be fastened together to form the part of the modular earth boring bit body 20. Further, the embodiment of the modular earth boring bit body 20 comprises identical blade pieces 24. Additional embodiments of the modular earth boring bit bodies may comprise blade pieces that are not identical. For example, the blade pieces may independently comprise materials of construction including but not limited to cemented hard particles, metallic alloys (including, but limited to, iron based alloys, nickel based alloys, copper, aluminum, and/or titanium based alloys), ceramics, plastics, or combinations thereof. The blade pieces may also include different designs including different locations of the cutting insert pockets and mud holes or other features as desired. In addition, the modular earth boring bit body includes blade pieces that are parallel to the axis of rotation of the bit body. Other embodiments may include blade pieces pitched at an angle, such as 5° to 45° from the axis of rotation.

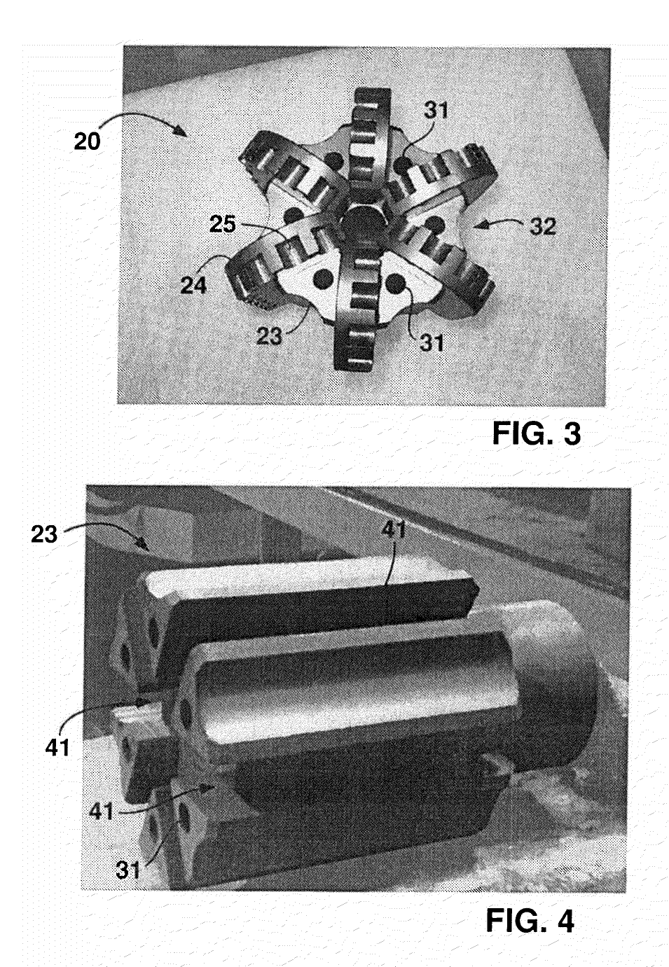

Further, the attachment portion 21, the shank 22, blade support piece 23, and blade pieces 24 may each independently be made of any desired material of construction that may be fastened together. The individual pieces of an embodiment of the modular fixed cutter earth-boring bit body may be attached together by any method such as, but not limited to, brazing, threaded connections, pins, keyways, shrink fits, adhesives, diffusion bonding, interference fits, or any other mechanical connection. As such, the bit body 20 may be constructed having various regions or pieces, and each region or piece may comprise a different concentration, composition, and crystal size of hard particles or binder, for example. This allows for tailoring the properties in specific regions and pieces of the bit body as desired for a particular application. As such, the bit body may be designed so the properties or composition of the pieces or regions in a piece change abruptly or more gradually between different regions of the article. The example, modular bit body 20 of FIG. 2, comprises two distinct zones defined by the six blade pieces 24 and blade support piece 23. In one embodiment, the blade support piece 23 may comprise a discontinuous hard phase of tungsten and/or tungsten carbide and the blade pieces 24 may comprise a discontinuous hard phase of fine cast carbide, tungsten carbide, and/or sintered cemented carbide particles. The blade pieces 24 also include cutter pockets 25 along the edge of the blade pieces 24 into which cutting inserts may be disposed; there are nine cutter pockets 25 in the embodiment of FIG. 2. The cutter pockets 25 may, for example, be incorporated directly in the bit body by the mold, such as by machining the green or brown billet, or as pieces fastened to a blade piece by brazing or another attachment method. As seen in FIG. 3, embodiments of the modular bit body 24 may also include internal fluid courses 31, ridges, lands, nozzles, junk slots 32, and any other conventional topographical features of an earth-boring bit body. Optionally, these topographical features may be defined by additional pieces that are fastened at suitable positions on the modular bit body.

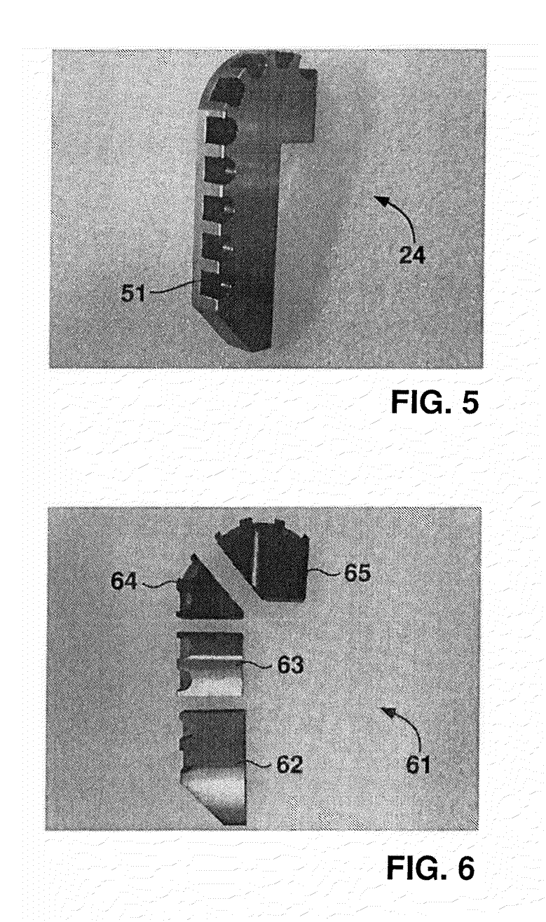

FIG. 4 is a photograph of the embodiment of the blade support piece 23 of FIGS. 2 and 3. The blade support piece 23 in this embodiment is made of cemented carbides and comprises internal fluid courses 31 and blade slots 41. FIG. 5 is a photograph of an embodiment of a blade piece 24 that may be inserted in the blade slot 41 of blade support piece 23 of FIG. 4. The blade piece 24 includes nine cutter insert pockets 51. As shown in FIG. 6, a further embodiment of a blade piece includes a blade piece 61 comprising several individual pieces 62, 63, 64 and 65. This multi-piece embodiment of the blade piece allows further customization of the blade for each blade slot and allows replacement of individual pieces of the blade piece 61 if a bit body is to be refurbished or modified, for example.

The use of the modular construction for earth boring bit bodies overcomes several of the limitations of one-piece bit bodies, for example: 1) The individual components of a modular bit body are smaller and less complex in shape as compared to a solid, one-piece, cemented carbide bit body. Therefore, the components will suffer less distortion during the sintering process and the modular bit bodies and the individual pieces can be made within closer tolerances. Additionally, key mating surfaces and other features, can be easily and inexpensively ground or machined after sintering to ensure an accurate and precision fit between the components, thus ensuring that cutter pockets and the cutting inserts may be located precisely at the predetermined positions. In turn, this would ensure optimum operation of the earth boring bit during service. 2) The less complex shapes of the individual components of a modular bit body allows for the use of much simpler (less sophisticated) machine tools and machining operations for the fabrication of the components. Also, since the modular bit body is made from individual components, there is far less concern regarding the interference of any bit body feature with the path of the cutting tool or other part of the machine during the shaping process. This allows for the fabrication of far more complex shaped pieces for assembly into bit bodies compared with solid, one-piece, bit bodies. The fabrication of similar pieces may be produced in more complex shapes allowing the designer to take full advantage of the superior properties of cemented carbides and other materials. For example, a larger number of blades may be incorporated into a modular bit body than in a one-piece bit body. 3) The modular design consists of an assembly of individual components and, therefore, there would be very little waste of expensive cemented carbide material during the shaping process. 4) A modular bit body allows for the use of a wide range of materials (cemented carbides, steels and other metallic alloys, ceramics, plastics, etc.) that can be assembled together to provide a bit body having the optimum properties at any location on the bit body. 5) Finally, individual blade pieces may be replaced, if necessary or desired, and the earth boring bit could be put back into service. In the case of a blade piece comprising multiple pieces, the individual pieces could be replaced. It is thus not necessary to discard the entire bit body due to failure of just a portion of the bit body, resulting in a dramatic decrease in operational costs.

The cemented carbide materials that may be used in the blade pieces and the blade support piece may include carbides of one or more elements belonging to groups IVB through VIB of the periodic table. Preferably, the cemented carbides comprise at least one transition metal carbide selected from titanium carbide, chromium carbide, vanadium carbide, zirconium carbide, hafnium carbide, tantalum carbide, molybdenum carbide, niobium carbide, and tungsten carbide. The carbide particles preferably comprise about 60 to about 98 weight percent of the total weight of the cemented carbide material in each region. The carbide particles are embedded within a matrix of a binder that preferably constitutes about 2 to about 40 weight percent of the total weight of the cemented carbide.

In one non-limiting embodiment, a modular fixed cutter earth-boring bit body according to the present disclosure includes a blade support piece comprising a first cemented carbide material and at least one blade piece comprised of a second cemented carbide material, wherein the at least one blade piece is fastened to the blade support piece, and wherein at least one of the first and second cemented carbide materials includes tungsten carbide particles having an average grain size of 0.3 to 10 μm. According to an alternate non-limiting embodiment, one of the first and second cemented carbide materials includes tungsten carbide particles having an average grain size of 0.5 to 10 μm, and the other of the first and second cemented carbide materials includes tungsten carbide particles having an average grain size of 0.3 to 1.5 μm. In yet another alternate non-limiting embodiment, one of the first and second cemented carbide materials includes 1 to 10 weight percent more binder (based on the total weight of the cemented carbide material) than the other of the first and second cemented carbide materials. In still another non-limiting alternate embodiment, a hardness of the first cemented carbide material is 85 to 90 HRA and a hardness of the second cemented carbide material is 90 to 94 HRA. In still a further non-limiting alternate embodiment, the first cemented carbide material comprises 10 to 15 weight percent cobalt alloy and the second cemented carbide material comprises 6 to 15 weight percent cobalt alloy. According to yet another non-limiting alternate embodiment, the binder of the first cemented carbide and the binder of the second cemented carbide differ in chemical composition. In yet a further non-limiting alternate embodiment, a weight percentage of binder of the first cemented carbide differs from a weight percentage of binder in the second cemented carbide. In another non-limiting alternate embodiment, a transition metal carbide of the first cemented carbide differs from a transition metal carbide of the second cemented carbide in at least one of chemical composition and average grain size. According to an additional non-limiting alternate embodiment, the first and second cemented carbide materials differ in at least one property. The at least one property may be selected from, for example, modulus of elasticity, hardness, wear resistance, fracture toughness, tensile strength, corrosion resistance, coefficient of thermal expansion, and coefficient of thermal conductivity.

The binder of the cemented hard particles or cemented carbides may comprise, fro example, at least one of cobalt, nickel, iron, or alloys of these elements. The binder also may comprise, for example, elements such as tungsten, chromium, titanium, tantalum, vanadium, molybdenum, niobium, zirconium, hafnium, and carbon up to the solubility limits of these elements in the binder. Further, the binder may include one or more of boron, silicon, and rhenium. Additionally, the binder may contain up to 5 weight percent of elements such as copper, manganese, silver, aluminum, and ruthenium. One skilled in the art will recognize that any or all of the constituents of the cemented hard particle material may be introduced in elemental form, as compounds, and/or as master alloys. The blade support piece and the blade pieces, or other pieces if desired, independently may comprise different cemented carbides comprising tungsten carbide in a cobalt binder. In one embodiment, the blade support piece and the blade piece include at least two different cemented hard particles that differ with respect to at least one property.

Embodiments of the pieces of the modular earth boring bit may also include hybrid cemented carbides, such as, but not limited to, any of the hybrid cemented carbides described in co-pending U.S. patent application Ser. No. 10/735,379, which is hereby incorporated by reference in its entirety.

A method of producing a modular fixed cutter earth-boring bit according to the present invention comprises fastening at least one blade piece to a blade support piece. The method may include fastening additional pieces together to produce the modular earth boring bit body including internal fluid courses, ridges, lands, nozzles, junk slots and any other conventional topographical features of an earth-boring bit body. Fastening an individual blade piece may be accomplished by any means including, for example, inserting the blade piece in a slot in the blade support piece, brazing, welding, or soldering the blade piece to the blade support piece, force fitting the blade piece to the blade support piece, shrink fitting the blade piece to the blade support piece, adhesive bonding the blade piece to the blade support piece (such as with an epoxy or other adhesive), or mechanically affixing the blade piece to the blade support piece. In certain embodiments, either the blade support piece or the blade pieces has a dovetail structure or other feature to strengthen the connection.

The manufacturing process for cemented hard particle pieces would typically involve consolidating metallurgical powder (typically a particulate ceramic and powdered binder metal) to form a green billet. Powder consolidation processes using conventional techniques may be used, such as mechanical or hydraulic pressing in rigid dies, and wet-bag or dry-bag isostatic pressing. The green billet may then be presintered or fully sintered to further consolidate and densify the powder. Presintering results in only a partial consolidation and densification of the part. A green billet may be presintered at a lower temperature than the temperature to be reached in the final sintering operation to produce a presintered billet (“brown billet”). A brown billet has relatively low hardness and strength as compared to the final fully sintered article, but significantly higher than the green billet. During manufacturing, the article may be machined as a green billet, brown billet, or as a fully sintered article. Typically, the machinability of a green or brown billet is substantially greater than the machinability of the fully sintered article. Machining a green billet or a brown billet may be advantageous if the fully sintered part is difficult to machine or would require grinding rather than machining to meet the required final dimensional tolerances. Other means to improve machinability of the part may also be employed such as addition of machining agents to close the porosity of the billet. A typical machining agent is a polymer. Finally, sintering at liquid phase temperature in conventional vacuum furnaces or at high pressures in a SinterHip furnace may be carried out. The billet may be over pressure sintered at a pressure of 300-2000 psi and at a temperature of 1350-1500° C. Pre-sintering and sintering of the billet causes removal of lubricants, oxide reduction, densification, and microstructure development. As stated above, subsequent to sintering, the pieces of the modular bit body may be further appropriately machined or ground to form the final configuration.

One skilled in the art would understand the process parameters required for consolidation and sintering to form cemented hard particle articles, such as cemented carbide cutting inserts. Such parameters may be used in the methods of the present invention.

Additionally, for the purposes of this invention, metallic alloys include alloys of all structural metals such as iron, nickel, titanium, copper, aluminum, cobalt, etc. Ceramics include carbides, borides, oxides, nitrides, etc. of all common elements.

It is to be understood that the present description illustrates those aspects of the invention relevant to a clear understanding of the invention. Certain aspects of the invention that would be apparent to those of ordinary skill in the art and that, therefore, would not facilitate a better understanding of the invention have not been presented in order to simplify the present description. Although embodiments of the present invention have been described, one of ordinary skill in the art will, upon considering the foregoing description, recognize that many modifications and variations of the invention may be employed. All such variations and modifications of the invention are intended to be covered by the foregoing description and the following claims.

1. A method of producing a modular fixed cutter earth-boring bit body, comprising:
providing a blade support piece;
providing at least one blade piece, wherein each blade piece comprises at least two individual segments; and
fastening the at least one blade piece to the blade support piece.

2. The method of producing a modular fixed cutter earth-boring bit body of claim 1, wherein fastening the at least one blade piece comprises at least one of inserting each of the at least two individual segments of each blade piece in a slot in the blade support piece, welding each of the at least two individual segments of each blade piece to the blade support piece, brazing each of the at least two individual segments of each blade piece to the blade support piece, soldering each of the at least two individual segments of each blade piece to the blade support piece, force fitting each of the at least two individual segments of each blade piece to the blade support piece, shrink fitting each of the at least two individual segments of each blade piece to the blade support piece, adhesive bonding each of the at least two individual segments of each blade piece to the blade support piece, attaching each of the at least two individual segments of each blade piece to the blade support piece with a threaded mechanical fastener, and mechanically affixing each of the at least two individual segments of each blade piece to the blade support piece.

3. The method of producing a modular fixed cutter earth-boring bit body of claim 1, wherein each of the at least two individual segments of the at least one blade piece comprises cemented hard particles.

4. The method of producing a modular fixed cutter earth-boring bit body of claim 3, wherein the cemented hard particles are cemented carbide.

5. The method of producing a modular fixed cutter earth-boring bit body of claim 1, wherein the blade support piece comprises at least one of cemented hard particles and a steel alloy.

6. The method of producing a modular fixed cutter earth-boring bit body of claim 5, wherein the blade support piece comprises cemented carbide.

7. The method of producing a modular fixed cutter earth-boring bit body of claim 6, wherein the blade support piece consists essentially of cemented carbide.

8. The method of producing a modular fixed cutter earth-boring bit body of claim 1, wherein the blade support piece and each of the at least two individual segments of the at least one blade piece each independently comprise a cemented carbide including particles of at least one carbide in a binder, wherein the at least one carbide is a carbide of a transition metal selected from titanium, chromium, vanadium, zirconium, hafnium, tantalum, molybdenum, niobium, and tungsten, and wherein the binder comprises at least one metal selected from cobalt, nickel, iron, cobalt alloy, nickel alloy, and iron alloy.

9. The method of producing a modular fixed cutter earth-boring bit body of claim 8, wherein the binder of the cemented carbide of the blade support piece and the binder of the cemented carbide of each of the at least two individual segments of the at least one blade piece each independently further comprise an alloying agent selected from tungsten, titanium, tantalum, niobium, chromium, molybdenum, boron, carbon, silicon, ruthenium, rhenium, manganese, aluminum, copper, vanadium, zirconium, and hafnium.

10. The method of producing a modular fixed cutter earth-boring bit body of claim 8, wherein the carbide is tungsten carbide and the binder comprises cobalt.

11. The method of producing a modular fixed cutter earth-boring bit body of claim 8, wherein providing each of the at least two individual segments of the at least one blade piece comprises compacting a powdered metal into a green compact, machining the green compact, and sintering the machined green compact.

12. The method of producing a modular fixed cutter earth-boring bit body of claim 11, wherein providing the blade support piece comprises compacting a powdered metal into a green compact, machining the green compact, and sintering the machined green compact.

13. The method of producing a modular fixed cutter earth-boring bit of any of claims 11 and 12, wherein the powdered metal comprises a metal carbide powder and a binder powder.

14. The method of producing a modular fixed cutter earth-boring bit body of claim 1, further comprising machining at least one insert pocket into the at least one blade piece.

15. A method of producing a modular fixed cutter earth-boring bit comprising:
providing the modular fixed cutter earth-boring bit body wherein the modular fixed cutter earth-boring bit body comprises:
a blade support piece; and
at least one blade piece fastened to the blade support piece, wherein each blade piece comprises at least two individual segments; and
fastening at least one cutting insert to the at least one blade piece.
